(19) United States
(12) Patent Application Publication
(10) Pub. No.: US 2007/0215059 A1
(43) Pub. Date: Sep. 20, 2007

(54) Cat litter net

(76) Inventor: Reiko Miyazawa Sefranek, Wheat Ridge, CO (US)

Correspondence Address: REIKO SEFRANEK, 11000 W. 38TH AVENUE # 204, WHEAT RIDGE, CO, 80033, US

(21) Appl. No.: 11/517,037

(22) Filed: Sep. 8, 2006

(30) Foreign Application Priority Data
Mar. 16, 2006 (JP) 2006-111334

(51) Int. Cl. A01K 29/00

(52) U.S. Cl. 119/170

(57) ABSTRACT

The present invention is a cat litter net that is a thin and soft sheet to remove waste material from scoopable cat litter. By arranging this net on the bottom of cat litter box, then the scoopable litter on the top of the net, when just pulling the net to above, only waste material is separated from the clean litter quickly without making dusts.

### CROSS-REFERENCES TO RELATED APPLICATIONS

Not Applicable

### BACKGROUND OF THE INVENTION

1. Field of the invention

The present invention relates generally to a cat litter net for removing waste material from a cat litter box. Specifically, it relates to such flexible lining net that can be arranged to the bottom of a cat litter box to filtrate and remove clumped waste material therefrom.

2. Discussion of Prior Art

The use of a cat litter scoop is known in the prior art. Cat litter scoops are typically made of mesh to separate waste from the litter box. U.S. Pat. No. 5,738,399 shows the cat litter scoop; however, using such scoop can make dust which may bother users and it also takes a while for them to clean up the litter.

### OBJECTS AND ADVANTAGES

Accordingly, several objects and advantages of the present invention are:

(a) to remove clumped waste quickly

(b) to remove clumped waste without making any dusts

### SUMMARY

According to the invention, using the cat litter net catches to remove clumped waste materials easily and quickly from cat litter box without making dusts.

### DESCRIPTION OF THE DRAWINGS

In the drawings, closely related parts in each figure have the same number, but different alphabetic suffixes.

FIGS. 1 to 5 show various aspects of the present invention.

FIG. 1 shows the invention looking from above. The hatching shows the netting: that is the structure of the invention.

FIG. 2 shows the exploded view of the invention. The hatching shows the netting: that is the structure of the invention.

FIG. 3 shows the sectional view of the invention with a cat litter box and litter; both clean litter and waste materials.

FIG. 4 shows the sectional view of the invention that is separating the waste materials to clean litter.

FIG. 5 shows the sectional view of the final operation of removing waste materials.

Number 1 is the surface that attaches to the bottom of the invention.

Number 2a-2d is the surface that attaches to the each side of the invention.

Number 3 is a typical cat litter box.

Number 4 is material in the cat litter box; both waste materials (4a) and clean litter (4b).

Number 5 is a user's hand when finishing.

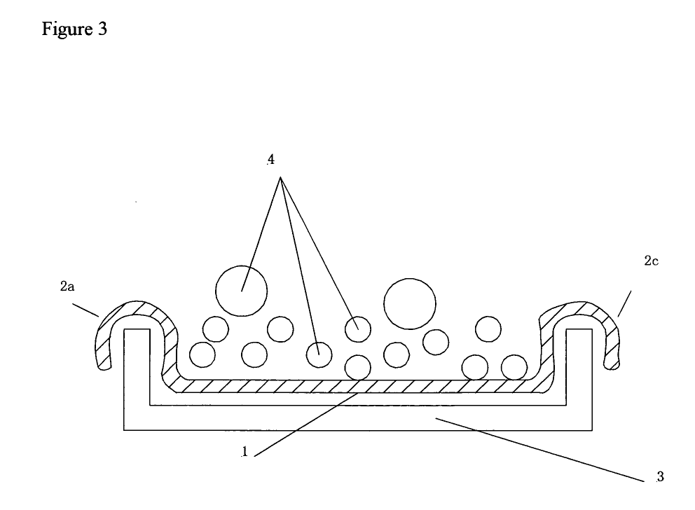

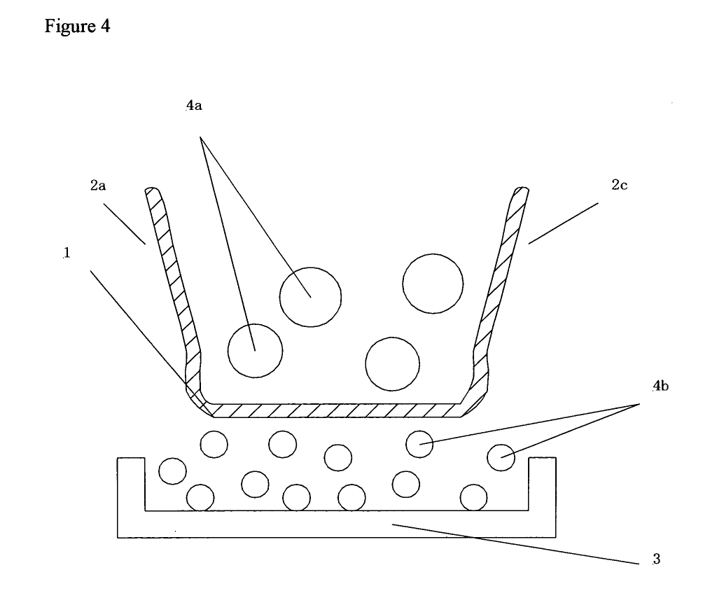

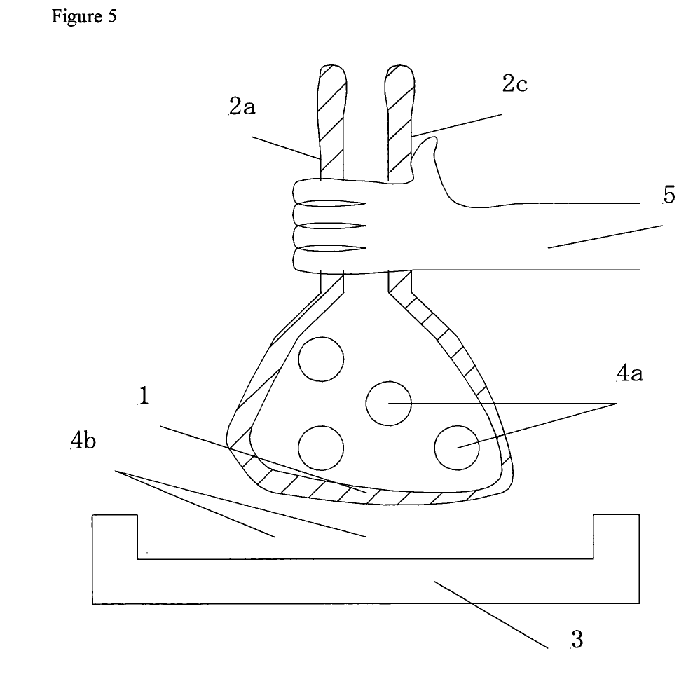

The physical structure of this invention is a sheet of net that is a very thin liner. However, in the FIGS. 3-5 it is drawn thick in order to show the hatching that shows the sectional views.

### DETAILED DESCRIPTION

### Description of Invention—Preferred Embodiment

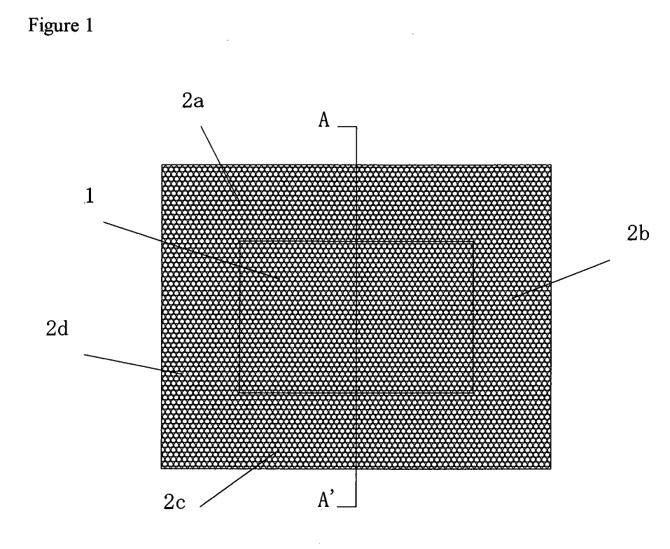

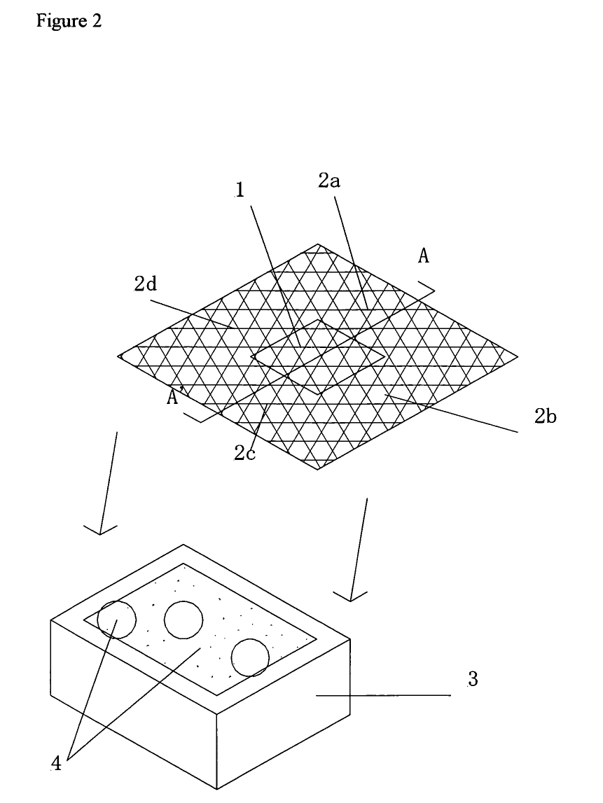

A preferred embodiment of the cat litter net of the present invention is illustrated in FIG. 1 and FIG. 2. The bottom of the net which is showed as number 1 in FIG. 1, and the sides of the net which are showed as numbers 2a-2d is all flexible, preferably made of material that is strong to support the waste material but gentle to the environment. The flexible net adheres to the inside contours and wraps over the lip of the cat litter box. Once the net is in place the cat litter can be added in the litter box. Size of the net changes depending on size of a litter box.

### Operation of Invention

The manner of using the cat litter net is first to arrange the cat litter net as lining of the cat litter box from bottom to the sides. Next, cat litter can be added on the top of the cat litter net. After your pet has used the litter box, to remove waste materials, pull the net from all sides to the center and lift it up to clean the waste material out of the litter. Finally, place the net and waste materials in trash receptacle.

1. A flexible net, comprising:
thin and strong sheet that has holes as a structure of a general net means so as to enable said net means to be able to filtrate waste materials from clean cat litter for cleaning the cat litter box.
